(19) United States
(12) Patent Application Publication
(10) Pub. No.: US 2023/0315168 A1
(43) Pub. Date: Oct. 5, 2023

(54) SUSPENSION TYPE SUPPORTING DEVICE

(71) Applicant: EVGA CORPORATION, New Taipei City (TW)

(72) Inventor: Tai-Sheng HAN, New Taipei City (TW)

(21) Appl. No.: 17/808,100

(22) Filed: Jun. 21, 2022

(30) Foreign Application Priority Data
Mar. 30, 2022 (TW) 111203248

(51) Int. Cl. G06F 1/18; F16M 13/02

(52) U.S. Cl. CPC G06F 1/186; F16M 13/02

(57) ABSTRACT

A suspension type supporting device includes a wire, a first fixing member, an adjusting member, and a second fixing member. The first fixing member is connected to a first portion of the wire and configured to be fixed to a first object. The adjusting member is connected to a second portion of the wire and adjustably connected to a third portion of the wire located between the first portion and the second portion. The second fixing member is movably connected to a fourth portion of the wire located between the second portion and the third portion, and is configured to be fixed to a second object.

### CROSS-REFERENCE TO RELATED APPLICATION

This application claims priority to Taiwan Application Serial Number 111203248, filed Mar. 30, 2022, which is herein incorporated by reference.

### BACKGROUND

### Technical Field

The present disclosure relates to a suspension type supporting device, and more particularly, to a suspension type supporting device for supporting a display card.

### Description of Related Art

A computer mainly has components such as a casing, a power supply, a motherboard, a central processing unit, a display card, an interface card, and a random access memory. Most of the aforementioned components are installed inside the casing.

At present, the computing power of the graphics processor of the display card is more and more powerful, so the weight of the display card also increases a lot. However, if this kind of heavy display card is only supported by the slot on the motherboard (such as the PCI-E slot), not only the slot is easily deformed after use, but also the pins between the display card and the slot are prone to wear out, resulting in poor contact.

Accordingly, how to provide a suspension type supporting device to solve the aforementioned problems becomes an important issue to be solved by those in the industry.

### SUMMARY

An aspect of the disclosure is to provide a suspension type supporting device that can efficiently solve the aforementioned problems.

According to an embodiment of the disclosure, a suspension type supporting device includes a wire, a first fixing member, an adjusting member, and a second fixing member. The first fixing member is connected to a first portion of the wire and configured to be fixed to a first object. The adjusting member is connected to a second portion of the wire and adjustably connected to a third portion of the wire located between the first portion and the second portion. The second fixing member is movably connected to a fourth portion of the wire located between the second portion and the third portion, and is configured to be fixed to a second object.

In an embodiment of the disclosure, the second portion is adjacent to the third portion. The wire extends from the third portion and folds back to the second portion.

In an embodiment of the disclosure, the adjusting member includes a main body portion and a clamping portion. The clamping portion is engaged with the main body portion and configured to detachably clamp the third portion of the wire between the main body portion and the clamping portion.

In an embodiment of the disclosure, the main body portion has a through hole. The wire slidably passes through the through hole. A portion of the wire located in the through hole is defined as the third portion.

In an embodiment of the disclosure, the main body portion further has a screw hole. The screw hole is communicated with the through hole. The clamping portion has a threaded portion engaged with the screw hole. The clamping portion is configured to abut against the third portion through the screw hole.

In an embodiment of the disclosure, the first fixing member includes an abutting portion and an abutting portion. The abutting portion is configured to abut against the first object and has an opening. The fastening portion is configured to pass through the opening and fastened to the first object.

In an embodiment of the disclosure, the first fixing member includes an abutting portion and an engaging portion. The abutting portion is configured to abut against the first object. The engaging portion is connected to the abutting portion and configured to be engaged with the first object.

In an embodiment of the disclosure, the engaging portion includes a neck portion and a head portion. The neck portion is connected to the abutting portion. The head portion is connected to the neck portion and laterally extends relative to the neck portion.

In an embodiment of the disclosure, the head portion has a first width and a second width in two directions perpendicular to each other. The second width is greater than the first width.

In an embodiment of the disclosure, the first fixing member further includes a main body portion. The main body portion is connected to the abutting portion. The first fixing member is connected to the first portion of the wire by the main body portion.

In an embodiment of the disclosure, the main body portion and the abutting portion are detachably connected.

In an embodiment of the disclosure, one of the main body portion and the abutting portion has an engaging hole. Another of the main body portion and the abutting portion has a hook. The hook is configured to be detachably engaged with the engaging hole.

In an embodiment of the disclosure, the first fixing member includes a main body portion and a clamping portion. The clamping portion is engaged with the main body portion and configured to detachably clamp the first portion of the wire between the main body portion and the clamping portion.

In an embodiment of the disclosure, the main body portion has a through hole. The wire slidably passes through the through hole. A portion of the wire located in the through hole is defined as the first portion.

In an embodiment of the disclosure, the main body portion further has a screw hole. The screw hole is communicated with the through hole. The clamping portion has a threaded portion engaged with the screw hole. The clamping portion is configured to abut against the first portion through the screw hole.

In an embodiment of the disclosure, the second fixing member includes a movable pulley and an engaging block. The movable pulley is slidably connected to the fourth portion of the wire. The engaging block is connected to the movable pulley and configured to engage with the second object.

According to an embodiment of the disclosure, a suspension type supporting device includes a wire, a first fixing member, an adjusting member, and a second fixing member. The first fixing member is connected to a first portion of the wire and configured to be fixed to a first object. The first fixing member is adjacent to an end of the wire. The adjusting member is connected to a second portion of the wire and adjustably connected to a third portion of the wire located between the first portion and the second portion along the wire. The second portion is adjacent to another end of the wire. The second fixing member is movably connected to a fourth portion of the wire located between the second portion and the third portion along the wire, and is configured to be fixed to a second object.

Accordingly, in the suspension type supporting device of the present disclosure, the first fixing member and the second fixing member can be respectively fixed to the first object (such as the engaging plate of the casing or the heat sink fixed in the casing) and the second object (such as the display card), and the wire can be stretched between the first fixing member and the second fixing member, so the suspension type supporting device can support the second object under the first object in a suspending manner. In addition, the distance between the first fixing member and the second fixing member can be flexibly adjusted according to the actual distance between the first object and the second object by adjusting the adjusting member to be adjustably fixed to different positions of the wire.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a partial perspective view of a host and a suspension type supporting device according to an embodiment of the present disclosure;

FIG. 2 is a perspective view of the suspension type supporting device in FIG. 1;

FIG. 3 is a partial cross-sectional view of a wire and an adjusting member in FIG. 2;

FIG. 4 is a partial cross-sectional view of the wire and a first fixing member in FIG. 2;

FIG. 5 is a partial perspective view of a host and a suspension type supporting device according to another embodiment of the present disclosure;

FIG. 6 is a perspective view of the suspension type supporting device in FIG. 5; and

FIG. 7 is a perspective view of an abutting portion of a first fixing member in FIG. 6.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts. However, specific structural and functional details disclosed herein are merely representative for purposes of describing example embodiments, and thus may be embodied in many alternate forms and should not be construed as limited to only example embodiments set forth herein. Therefore, it should be understood that there is no intent to limit example embodiments to the particular forms disclosed, but on the contrary, example embodiments are to cover all modifications, equivalents, and alternatives falling within the scope of the disclosure.

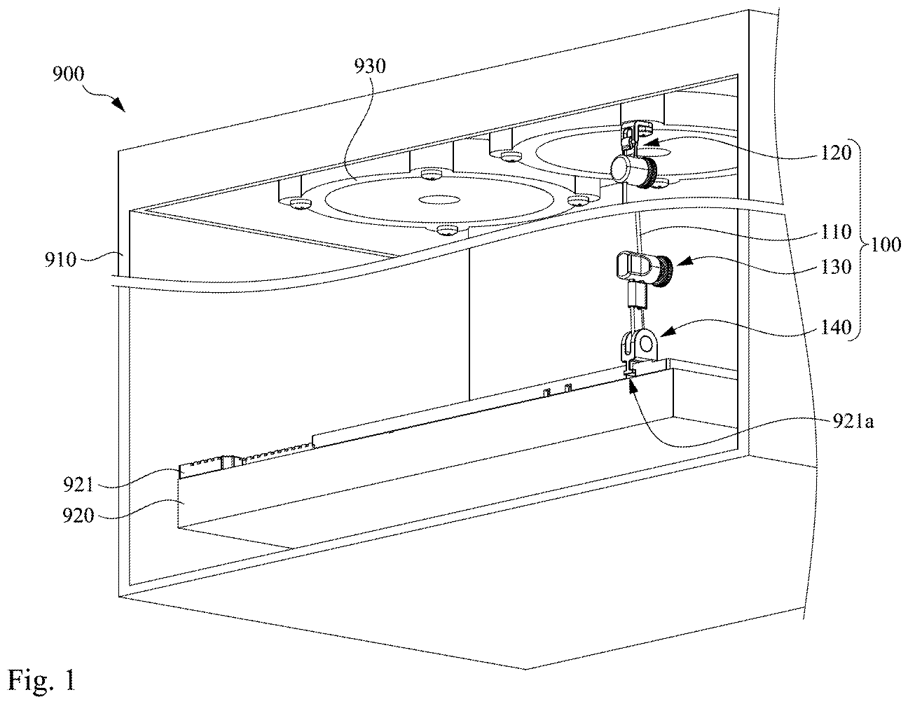

Reference is made to FIG. 1. FIG. 1 is a partial perspective view of a host 900 and a suspension type supporting device 100 according to an embodiment of the present disclosure. As shown in FIG. 1, in the present disclosure, the suspension type supporting device 100 is applied in the host 900. The host 900 includes a casing 910, a display card 920, and a heat dissipation device 930. The display card 920 is laterally inserted into a main board (not shown) disposed in the casing 910 with the interface terminals located at one edge thereof. The heat dissipation device 930 (e.g., a water cooling row) is disposed in the casing 910 and located above the display card 920. The suspension type supporting device 100 includes a wire 110, a first fixing member 120, and a second fixing member 140. The first fixing member 120 is configured to be fixed to the heat dissipation device 930. The second fixing member 140 is configured to be fixed to the display card 920. The wire 110 can be stretched between the first fixing member 120 and the second fixing member 140, so the suspension type supporting device 100 can support the display card 920 under the heat dissipation device 930 in a suspending manner. Therefore, the suspension type supporting device 100 of the present embodiment can solve the problem that the slot (e.g., the PCI-E slot) of the host 900 is deformed due to the sagging of the display card 920 after being used for a long time.

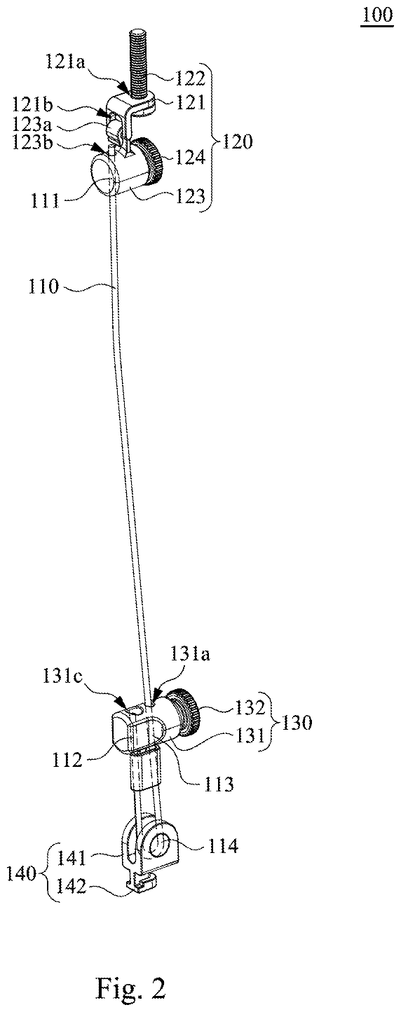

Reference is made to FIG. 2. FIG. 2 is a perspective view of the suspension type supporting device 100 in FIG. 1. As shown in FIG. 2, in the present embodiment, the first fixing member 120 is connected to a first portion 111 of the wire 110. The suspension type supporting device 100 further includes an adjusting member 130. The adjusting member 130 is connected to a second portion 112 of the wire 110 and adjustably connected to a third portion 113 of the wire 110 located between the first portion 111 and the second portion 112. The second fixing member 140 is movably connected to a fourth portion 114 of the wire 110 located between the second portion 112 and the third portion 113. Further, the second portion 112 of the wire 110 is adjacent to the third portion 113. Therefore, the wire 110 extends downward from the third portion 113 and is folded back to the second portion 112. When the first fixing member 120 and the second fixing member 140 are respectively fixed to the heat dissipation device 930 and the display card 920, the weight of the display card 920 will pull the second fixing member 140 in a direction away from the first fixing member 120, so that the wire 110 is reversely stretched by the first fixing member 120 and the second fixing member 140. In this way, the suspension type supporting device 100 can maintain the distance between the heat dissipation device 930 and the display card 920 and effectively prevent the display card 920 from sagging.

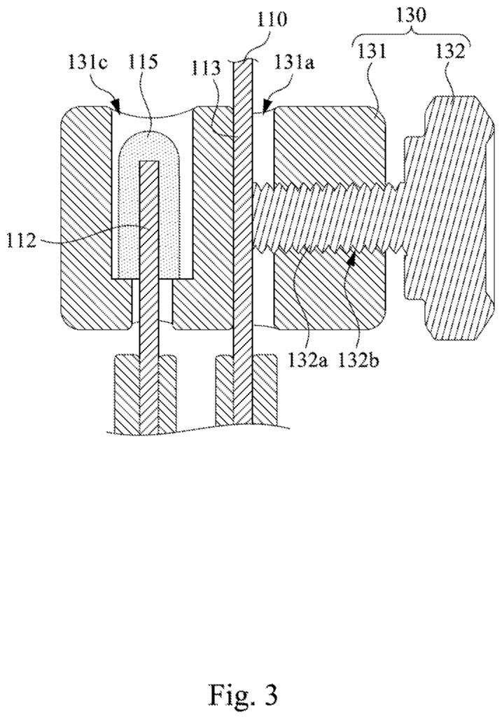

Reference is made to FIG. 3. FIG. 3 is a partial cross-sectional view of the wire 110 and the adjusting member 130 in FIG. 2. As shown in FIG. 3, in the present embodiment, the adjusting member 130 includes a main body portion 131 and a clamping portion 132. The clamping portion 132 is engaged with the main body portion 131 and configured to detachably clamp the third portion 113 of the wire 110 between the main body portion 131 and the clamping portion 132. Specifically, the main body portion 131 has a through hole 131a. The wire 110 slidably passes through the through hole 131a. The portion of the wire 110 located in the through hole 131a is defined as the third portion 113. In addition, the main body portion 131 further has a screw hole 131b. The screw hole 131b is communicated with the through hole 131a. The clamping portion 132 has a threaded portion 132a engaged with the screw hole 131b. The clamping portion 132 is configured to abut against the third portion 113 through the screw hole 131b. In this way, the adjusting member 130 can adjust the position of the clamped third portion 113 on the wire 110, thereby adjusting the distance between the first fixing member 120 and the second fixing member 140 for stretching the wire 110 in opposite directions. For example, when the third portion 113 clamped by the adjusting member 130 is closer to the first portion 111, the distance between the first fixing member 120 and the second fixing member 140 reversely stretching the wire 110 is smaller. When the third portion 113 clamped by the adjusting member 130 is farther away from the first portion 111, the distance between the first fixing member 120 and the second fixing member 140 reversely stretching the wire 110 is larger.

In the present disclosure, the clamping portion 132 of the adjusting member 130 can be, for example, a hand-turned screw, so as to allow the user to adjust the position of the third portion 113 clamped by the adjusting member 130 on the wire 110 in a tool-free manner, but the disclosure is not limited in this regard.

In some other embodiments, the clamping portion 132 of the adjusting member 130 may be an openable and closable clip, but the disclosure is not limited in this regard.

As shown in FIG. 3, in the present embodiment, the main body portion 131 of the adjusting member 130 further has a countersunk hole 131c therethrough. The portion of the wire 110 located in the countersunk hole 131c is defined as the second portion 112. The wire 110 further includes a stopping block 115 connected to the second portion 112 of the wire 110. The stopping block 115 can freely enter and exit the inlet of the countersunk hole 131c, and is configured to abut against the bottom of the countersunk hole 131c. When the wire 110 is reversely stretched by the first fixing member 120 and the second fixing member 140, the stopping block 115 abuts against the bottom of the countersunk hole 131c. Therefore, when the wire 110 is reversely stretched by the first fixing member 120 and the second fixing member 140, the second portion 112 to which the adjusting member 130 is connected is one end of the wire 110.

In some other embodiments, the second portion 112 of the wire 110 may be directly fixed on the adjusting member 130.

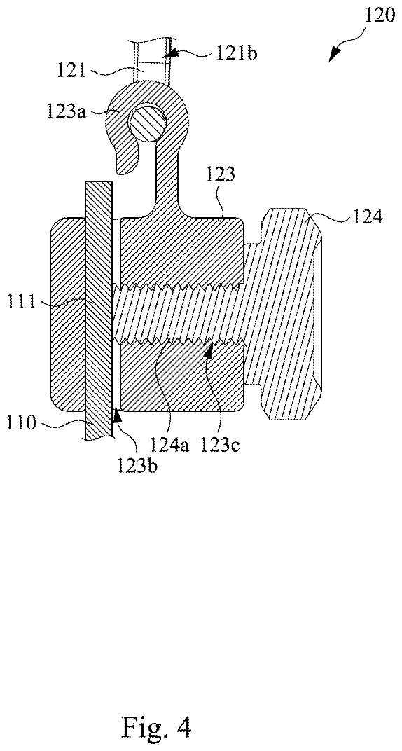

Reference is made to FIG. 4. FIG. 4 is a partial cross-sectional view of the wire 110 and the first fixing member 120 in FIG. 2. As shown in FIGS. 2 and 4, in the present embodiment, the first fixing member 120 includes an abutting portion 121 and a fastening portion 122. The abutting portion 121 is configured to abut against the heat dissipation device 930 and has an opening 121a. The fastening portion 122 is configured to pass through the opening 121a and be fastened to the heat dissipation device 930. For example, the fastening portion 122 is a screw, and the heat dissipation device 930 has a fastening hole. The fastening portion 122 passes through the opening 121a of the abutting portion 121 and is fastened to the fastening hole of the heat dissipation device 930, so as to clamp and fix the abutting portion 121 between the heat dissipation device 930 and the fastening portion 122.

As shown in FIGS. 2 and 4, in the present embodiment, the first fixing member 120 further includes a main body portion 123. The main body portion 123 is connected to the abutting portion 121. The first fixing member 120 is connected to the first portion 111 of the wire 110 by the main body portion 123. The main body portion 123 and the abutting portion 121 are detachably connected. Specifically, the abutting portion 121 has an engaging hole 121b. The main body portion 123 has a hook 123a. The hook 123a is configured to be detachably engaged with the engaging hole 121b. Therefore, when the first fixing member 120 is fixed to the heat dissipation device 930, the user can first use the fastening portion 122 to fix the abutting portion 121 to the heat dissipation device 930, and then engage the hook 123a of the main body portion 123 to the engaging hole 121b of the abutting portion 121, so as to conveniently complete the installation of the first fixing member 120.

In some other embodiments, the main body portion 123 and the abutting portion 121 may be two parts of a unitary structure.

As shown in FIG. 4, in the present embodiment, the first fixing member 120 further includes a clamping portion 124. The clamping portion 124 is engaged with the main body portion 123 and configured to detachably clamp the first portion 111 of the wire 110 between the main body portion 123 and the clamping portion 124. Specifically, the main body portion 123 has a through hole 123b. The wire 110 is slidably passed through the through hole 123b. The portion of the wire 110 located in the through hole 123b is defined as the first portion 111. In addition, the main body portion 123 further has a screw hole 123c. The screw hole 123c is communicated with the through hole 123b. The clamping portion 124 has a threaded portion 124a engaged with the screw hole 123c. The clamping portion 124 is configured to abut against the first portion 111 through the screw hole 123c. In this way, the first fixing member 120 can adjust the position of the clamped first portion 111 on the wire 110, thereby adjusting the distance between the first fixing member 120 and the second fixing member 140 stretching the wire 110 in the opposite directions. For example, when the first portion 111 clamped by the first fixing member 120 is closer to the third portion 113 clamped by the adjusting member 130, the distance between the first fixing member 120 and the second fixing member 140 of the reversely stretching the wire 110 is smaller. When the first portion 111 clamped by the first fixing member 120 is farther away from the third portion 113 clamped by the adjusting member 130, the distance between the first fixing member 120 and the second fixing member 140 reversely stretching the wire 110 is larger. By enabling the first fixing member 120 to adjust the position of the first portion 111 on the wire 110, the adjustable range of the suspension type supporting device 100 for adjusting the distance between the first fixing member 120 and the second fixing member 140 reversely stretching the wire 110 can be increased.

In the present embodiment, the clamping portion 124 of the first fixing member 120 can be, for example, a hand-turned screw, so that the user can adjust the position of the first portion 111 clamped by the adjusting member 130 on the wire 110 in a tool-free manner, but the present disclosure is not limited in this regard.

In some other embodiments, the clamping portion 124 of the first fixing member 120 may be an openable and closable clip, but the disclosure is not limited in this regard.

As shown in FIGS. 1 and 2, in the present embodiment, the display card 920 includes a back plate 921. The back plate 921 is located on the side of the display card 920 facing the heat dissipation device 930 and has an engaging groove 921a. The second fixing member 140 includes a movable pulley 141 and an engaging block 142. The movable pulley 141 is slidably connected to the fourth portion 114 of the wire 110. The portion where the wire 110 is connected to the movable pulley 141 is defined as the fourth portion 114. The engaging block 142 is connected to the movable pulley 141 and is configured to be engaged with the engaging groove 921a of the back plate 921.

In some other embodiments, the engaging block 142 of the second fixing member 140 may be an openable and closable clip, and is configured to clamp the edge of the back plate 921, but the present disclosure is not limited in this regard.

In some other embodiments, the engaging block 142 of the second fixing member 140 may include structures similar to the abutting portion 121 and the fastening portion 122 of the first fixing member 120, and is fixed to the back plate 921 in a similar fastening manner, but the present disclosure is not limited in this regard.

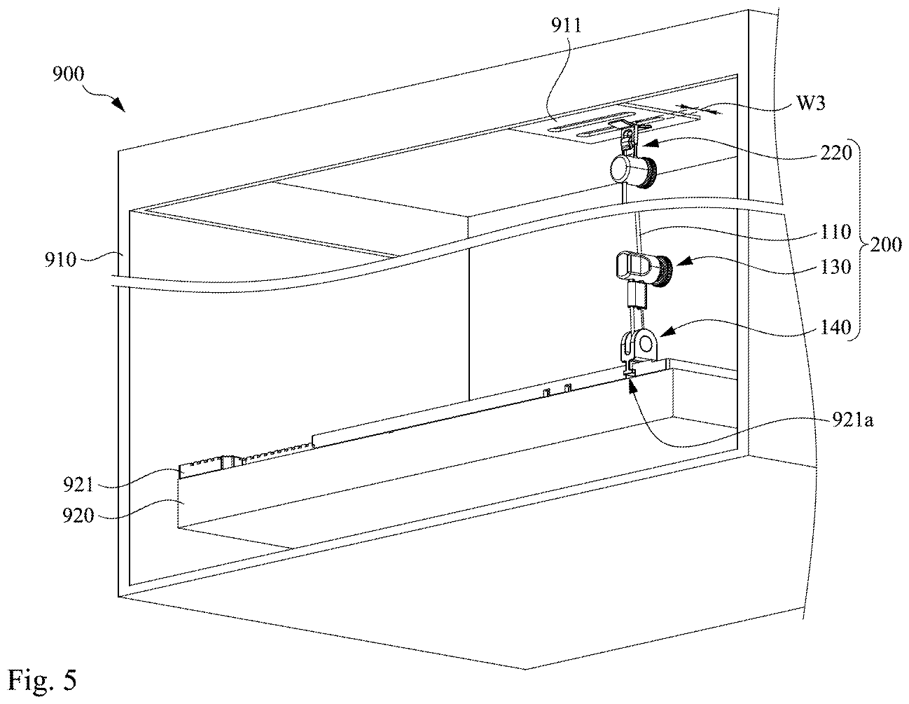

Reference is made to FIG. 5. FIG. 5 is a partial perspective view of a host 900 and a suspension type supporting device 200 according to another embodiment of the present disclosure. As shown in FIG. 5, in the present embodiment, the suspension type supporting device 200 is applied to the host 900. The host 900 includes a casing 910 and a display card 920. The display card 920 is laterally inserted into the main board (not shown) disposed in the casing 910 with the interface terminals located at one edge thereof. The casing 910 has an engaging plate 911. The suspension type supporting device 200 includes a wire 110, a first fixing member 220, a second fixing member 140, and an adjusting member 130. The first fixing member 220 is configured to be fixed with the engaging plate 911 of the casing 910. The second fixing member 140 is configured to be fixed with the display card 920. The wire 110 is stretched between the first fixing member 220 and the second fixing member 140, so the suspension type supporting device 200 can support the display card 920 under the engaging plate 911 in a suspension manner. In this way, the suspension type supporting device 200 of the present embodiment can solve the problem that the slot (e.g., the PCI-E slot) of the host 900 is deformed due to the sagging of the display card 920 after being used for a long time.

It should be noted that the wire 110, the second fixing member 140, and the adjusting member 130 of the suspension type supporting device 200 of the present embodiment are the same as the embodiment shown in FIG. 2, so the specific structures, functions, and connection relationships of these components can be referred to the above-mentioned related descriptions, which will not be repeated here. In other words, the suspension type supporting device 200 of the present embodiment provides a modified first fixing member 220.

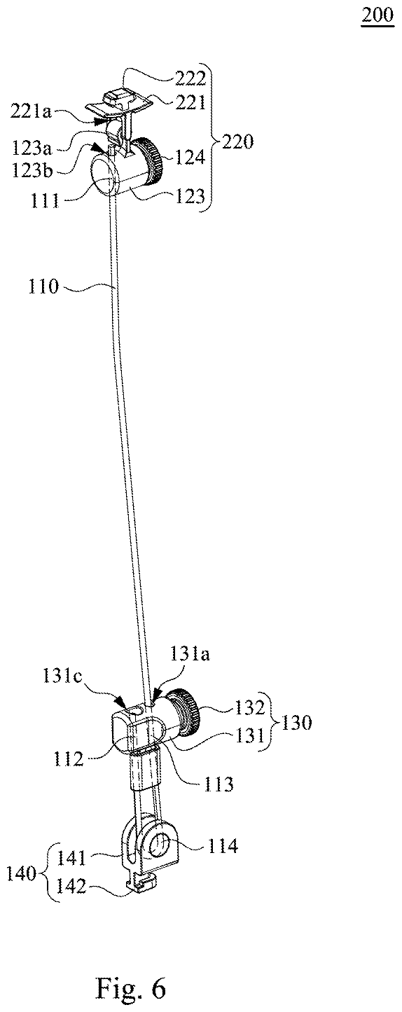

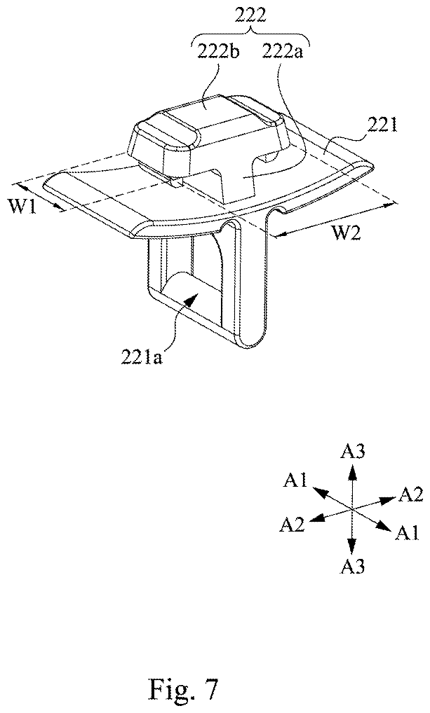

Specifically, reference is made to FIGS. 6 and 7. FIG. 6 is a perspective view of the suspension type supporting device 200 in FIG. 5. FIG. 7 is a perspective view of an abutting portion 221 of the first fixing member 220 in FIG. 6. As shown in FIGS. 6 and 7, in the present embodiment, the first fixing member 220 includes an abutting portion 221, an engaging portion 222, a main body portion 123, and a clamping portion 124, in which the main body portion 123 and the clamping portion 124 are the same as the embodiment shown in FIG. 2, so the specific structures, functions, and connection relationships of these components can be referred to the above-mentioned related descriptions, which will not be repeated here. With reference to FIG. 5, the engaging plate 911 has a hollow hole 911a. The abutting portion 221 of the first fixing member 220 is configured to abut against the engaging plate 911. The engaging portion 222 is connected to the abutting portion 221 and is configured to be engaged with the hollow hole 911a of the engaging plate 911. As shown in FIG. 7, the engaging portion 222 includes a neck portion 222a and a head portion 222b. The neck portion 222a is connected to the abutting portion 221. The head portion 222b is connected to the neck portion 222a and extends laterally relative to the neck portion 222a. Specifically, the head portion 222b has a first width W1 in the direction A1 and a second width W2 in the direction A2. The second width W2 is greater than the first width W1. In addition, the hollow hole 911a of the engaging plate 911 is an elongated slot hole and has a third width W3. The third width W3 is larger than the first width W1 and smaller than the second width W2. Therefore, when fixing the first fixing member 220 to the engaging plate 911, the user can first rotate the engaging portion 222 to pass through the hollow hole 911a with the smaller first width W1, and then rotate the engaging portion 222 to be engaged with the top surface of the engaging plate 911 in an orientation with a larger second width W2. At this time, the engaging plate 911 is sandwiched and fixed between the abutting portion 221 and the head portion 222b of the engaging portion 222. In addition, the portion of the bottom portion of the abutting portion 221 extending in the direction A3 has an engaging hole 221a. In this way, the user can then engage the hook 123a of the main body portion 123 with the engaging hole 221a of the abutting portion 221, and the installation of the first fixing member 220 can be completed conveniently.

In some embodiments, the abutting portion 221 extends substantially parallel to a plane formed by the directions A1 and A2, and the opposite edges of the abutting portion 221 are lifted toward the side close to the engaging portion 222, so as to firmly clamp and fix the engaging plate 911 between the abutting portion 221 and the head portion 222b of the engaging portion 222.

In some embodiments, the directions A1, A2, and A3 are perpendicular to each other, but the present disclosure is not limited in this regard.

In other embodiments, the main body portion 123 and the abutting portion 221 may be two parts of a unitary structure.

According to the foregoing recitations of the embodiments of the disclosure, it can be seen that in the suspension type supporting device of the present disclosure, the first fixing member and the second fixing member can be respectively fixed to the first object (such as the engaging plate of the casing or the heat sink fixed in the casing) and the second object (such as the display card), and the wire can be stretched between the first fixing member and the second fixing member, so the suspension type supporting device can support the second object under the first object in a suspending manner. In addition, the distance between the first fixing member and the second fixing member can be flexibly adjusted according to the actual distance between the first object and the second object by adjusting the adjusting member to be adjustably fixed to different positions of the wire.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A suspension type supporting device, comprising:
a wire;
a first fixing member connected to a first portion of the wire and configured to be fixed to a first object;
an adjusting member connected to a second portion of the wire and adjustably connected to a third portion of the wire located between the first portion and the second portion; and
a second fixing member movably connected to a fourth portion of the wire located between the second portion and the third portion, and is configured to be fixed to a second object.

2. The suspension type supporting device of claim 1, wherein the second portion is adjacent to the third portion, and the wire extends from the third portion and folds back to the second portion.

3. The suspension type supporting device of claim 1, wherein the adjusting member comprises:
a main body portion; and
a clamping portion engaged with the main body portion and configured to detachably clamp the third portion of the wire between the main body portion and the clamping portion.

4. The suspension type supporting device of claim 3, wherein the main body portion has a through hole, the wire slidably passes through the through hole, and a portion of the wire located in the through hole is defined as the third portion.

5. The suspension type supporting device of claim 4, wherein the main body portion further has a screw hole, the screw hole is communicated with the through hole, the clamping portion has a threaded portion engaged with the screw hole, and the clamping portion is configured to abut against the third portion through the screw hole.

6. The suspension type supporting device of claim 1, wherein the first fixing member comprises:
an abutting portion configured to abut against the first object and having an opening; and
a fastening portion configured to pass through the opening and fastened to the first object.

7. The suspension type supporting device of claim 6, wherein the first fixing member further comprises a main body portion, the main body portion is connected to the abutting portion, and the first fixing member is connected to the first portion of the wire by the main body portion.

8. The suspension type supporting device of claim 1, wherein the first fixing member comprises:
an abutting portion configured to abut against the first object; and
an engaging portion connected to the abutting portion and configured to be engaged with the first object.

9. The suspension type supporting device of claim 8, wherein the engaging portion comprises:
a neck portion connected to the abutting portion; and
a head portion connected to the neck portion and laterally extending relative to the neck portion.

10. The suspension type supporting device of claim 9, wherein the head portion has a first width and a second width in two directions perpendicular to each other, and the second width is greater than the first width.

11. The suspension type supporting device of claim 8, wherein the first fixing member further comprises a main body portion, the main body portion is connected to the abutting portion, and the first fixing member is connected to the first portion of the wire by the main body portion.

12. The suspension type supporting device of claim 11, wherein the main body portion and the abutting portion are detachably connected.

13. The suspension type supporting device of claim 12, wherein one of the main body portion and the abutting portion has an engaging hole, another of the main body portion and the abutting portion has a hook, and the hook is configured to be detachably engaged with the engaging hole.

14. The suspension type supporting device of claim 1, wherein the first fixing member comprises:
a main body portion; and
a clamping portion engaged with the main body portion and configured to detachably clamp the first portion of the wire between the main body portion and the clamping portion.

15. The suspension type supporting device of claim 14, wherein the main body portion has a through hole, the wire slidably passes through the through hole, and a portion of the wire located in the through hole is defined as the first portion.

16. The suspension type supporting device of claim 15, wherein the main body portion further has a screw hole, the screw hole is communicated with the through hole, the clamping portion has a threaded portion engaged with the screw hole, and the clamping portion is configured to abut against the first portion through the screw hole.

17. The suspension type supporting device of claim 1, wherein the second fixing member comprises:
a movable pulley slidably connected to the fourth portion of the wire; and
an engaging block connected to the movable pulley and configured to engage with the second object.

18. A suspension type supporting device, comprising:
a wire;
a first fixing member connected to a first portion of the wire and configured to be fixed to a first object, wherein the first fixing member is adjacent to an end of the wire;
an adjusting member connected to a second portion of the wire and adjustably connected to a third portion of the wire located between the first portion and the second portion along the wire, wherein the second portion is adjacent to another end of the wire; and
a second fixing member movably connected to a fourth portion of the wire located between the second portion and the third portion along the wire, and is configured to be fixed to a second object.
